(19) United States
(12) Patent Application Publication
(10) Pub. No.: US 2008/0243389 A1
(43) Pub. Date: Oct. 2, 2008

(54) Vehicle Collision Avoidance Equipment and Method

(75) Inventors: Takeshi Inoue, Hitachiota (JP); Hiroshi Sakamoto, Hitachi (JP); Takaomi Nishigaito, Kasumigaura (JP); Shin Yamauchi, Mito (JP); Mikio Ueyama, Ohira (JP); Tatsuhiko Monji, Hitachinaka (JP); Tatsuya Yoshida, Naka (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 12/015,782

(22) Filed: Jan. 17, 2008

(30) Foreign Application Priority Data
Mar. 26, 2007 (JP) 2007-078122

(51) Int. Cl. G08G 1/16

(52) U.S. Cl. 701/301

(57) ABSTRACT

An object recognizing means obtains a relative physical value between a movable body and an object such as at least one of the other movable body, an object on the ground, a position on the ground, a topographical feature and a regional information around the movable body, and a safety keeping area calculator calculates an imaginary safety keeping area around the movable body from the relative physical value, and an object intrusion judging means decides as to at least one of whether or not the object is within the safety keeping area and whether or not the object will be within the safety keeping area to perform at least one of controlling for preventing a collision between the movable body and the object and outputting an alarm, when deciding the at least one of that the object is within the safety keeping area and that the object will be within the safety keeping area.

### BACKGROUND OF THE INVENTION

The present invention relates to a technique for preventing a movable body from colliding.

Various techniques for improving a safety of a movable body by preventing a collision thereof have been developed. For example, another movable body is detected by a radar or camera, a time period to the collision is calculated from a distance to the detected another movable body and a relative velocity with respect to the detected another movable body, and a deceleration is performed when the calculated time period is not more than a threshold value.

JP-A-2005-100336 discloses that a movable body has a safety keeping area to perform a collision avoidance operation or output an alarm when the another movable body proceeds into the safety keeping area, and JP-A-2005-254835 discloses that the another movable body has the safety keeping area.

Further, JP-A-2005-56372 discloses that a shape of the safety keeping area is modified in accordance with a traveling direction of the movable body.

### BRIEF SUMMARY OF THE INVENTION

In the above prior art, the deceleration may be carried out when the another movable body is getting away from the movable body in a transverse direction, and there is an unfavorable aspect in calculation amount caused by that it is difficult for the safety keeping area of the another movable body to be modified in accordance with a predetermined change in traveling direction of the movable body so that a logical determination for the modification based on the predetermined change in traveling direction of the movable body is required after setting the safety keeping area.

An object of the present invention is to provide a technique for easily and accurately escaping from the collision.

According to the invention, an imaginary safety keeping area around a movable body is determined in accordance with a relative physical value between the movable body and the other movable body so that an escaping control or an alarm us carried out when it is decided that the other movable body will proceed into the safety keeping area.

The technique for easily and accurately escaping from the collision is obtained by the invention.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWINGS

FIG. 1 is a block diagram showing an apparatus for escaping from collision.

FIG. 2 is a schematic view showing a map of objects and a relative velocity vector.

FIG. 3 is a table showing the map of objects and the relative velocity vector.

FIG. 4 is a schematic view showing an example of a safety keeping area.

FIG. 5 is a schematic view showing another example of the safety keeping area.

FIG. 6 is a schematic view showing a plurality of the safety keeping areas.

FIG. 7 is a schematic view showing an example of the safety keeping area formed when a traffic lane change is intended.

FIG. 8 is a schematic view showing an example of the safety keeping area formed when turning rightward.

FIG. 9 is a schematic view showing an example of the safety keeping area formed just after a steering wheel is rotated.

FIG. 10 is a schematic view showing an example of the safety keeping area formed in accordance with an angle of the steering wheel.

FIG. 11 is a schematic view showing an example of deciding an escaping operation.

FIG. 12 is a schematic view showing an example of deciding a deceleration when the other vehicle is within the area of the vehicle.

FIG. 13 is a schematic view showing an example of escaping with rotating the steering wheel.

FIG. 14 is a schematic view showing an example of deceleration carried out when passing between the other vehicles.

FIG. 15 is a flow chart of control process of a collision escaping apparatus.

FIG. 16 is a schematic view showing an example of the safety keeping area modified vertically.

FIG. 17 is a schematic view showing another example of the safety keeping area modified vertically.

### DETAILED DESCRIPTION OF THE INVENTION

Hereafter, embodiments are described with an automobile as a movable body, but the movable body does not need to be limited to the automobile.

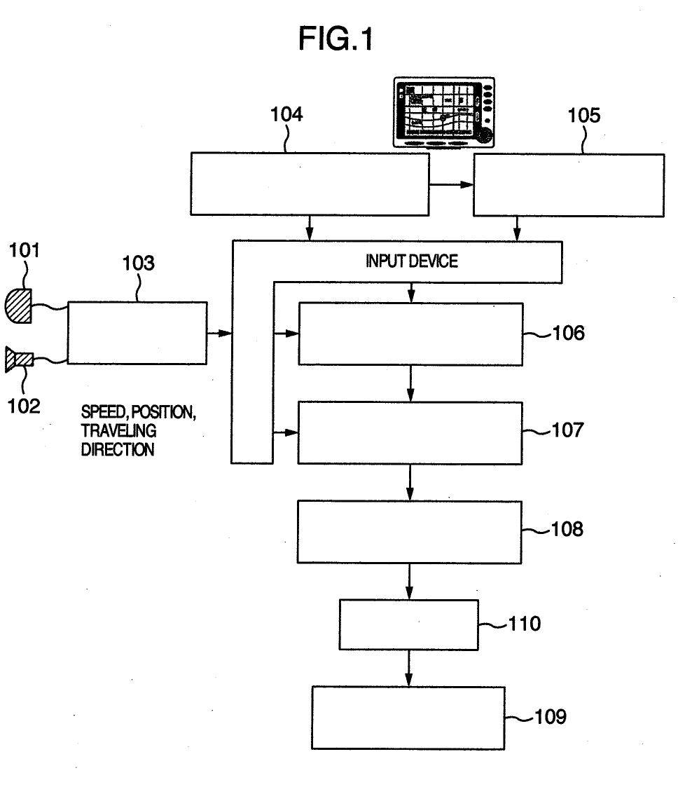

FIG. 1 is a block diagram showing an apparatus for escaping from collision.

In this system, the other automobile or a pedestrian is detected by a radar 101 and a camera 102 mounted on the vehicle, a road shape ahead and aside of the vehicle measured by a vehicle ahead road shape detector 105 and a position and traffic-lane of the vehicle detected by a vehicle position velocity traveling direction detector 104 are input through an input device 111 so that a safety keeping area is calculated by a safety keeping area extension calculator 106. When it is detected or predicted by an other vehicle safety keeping area intrusion detector 107 that the other vehicle intrudes or will intrude into the safety keeping area, a vehicle deceleration velocity steering-wheel setting device 108 determines a plan to be output through an outputting device 110 to a velocity steering-wheel controller 109 so that the vehicle escapes. Incidentally, an apparatus and method for escaping from collision of the invention is realized by a program executed by a navigation device or a controller with CPU (central processing unit). Further, in this embodiment, a signal for executing the plan for escaping (which signal may be an ordering signal, or a signal only indicating the intrusion usable to determine the plan for escaping at a signal receiving side) is transmitted through the outputting device 110 to the velocity steering-wheel controller 109, but only the alarm may be output. In such case, the outputting device 110 may output a signal for generating the alarm so that the signal receiving side carries out a predetermined alarm output operation. FIG. 1 is described in detail below.

The radar 101 and camera 102 mounted on the automobile detect the other automobile, a pedestrian, an obstacle and a traffic lane under the automobile to output information thereof to an object recognizing device 103. The information includes a distance (from the vehicle) to the other vehicle, pedestrian and obstacle, the traffic lane under the vehicle and a distance from a left or right end of the traffic lane.

For detecting the other vehicle or obstacle with the radar, there is a method in which a distance to the object in front of the vehicle, a relative velocity of the object and an angle toward the object are measured by emitting extremely high frequency wave to receive the reflected extremely high frequency wave as disclosed by “Anzen-soukousienn-system wo sasaeru kankyou-ninnsiki-gijutsu” in Hitachi-hyouron Vol 85, No. 5, pp-43-46, published on May 2004. The radar may use a laser or microwave.

A method for recognizing the other vehicle with the camera is disclosed by JP-A-2005-156199. In such method, an edge point of the other vehicle in front of the vehicle is detected by the camera measuring a change in brightness of the other vehicle to be analyzed. For detecting the pedestrian with the camera, the distance is determined from an azimuth difference detected by a stereo-camera. A technique for recognizing the traffic lane with the camera is disclosed by “Anzen-soukousienn-system wo sasaeru kankyou-ninnsiki-gijutsu” in Hitachi-hyouron Vol 85, No. 5, pp-43-46, published on May 2004.

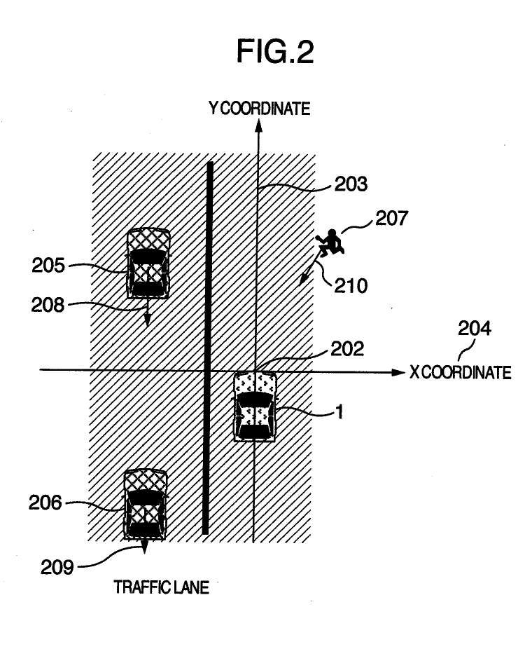

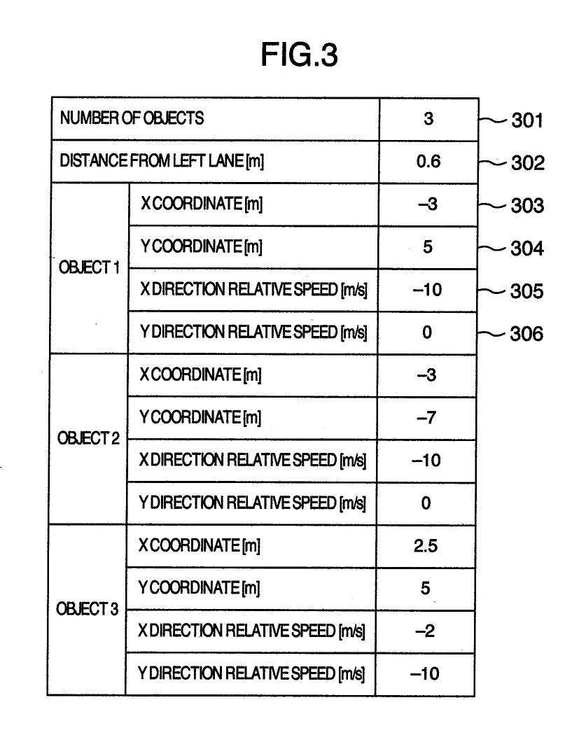

The object recognizing device 103 is described below. The object recognizing device 103 gathers information corresponding to distance and direction of the object (for example, the other vehicle or pedestrian as the other movable body, an object on the ground as the obstacle, a ground point including latitude and longitude, a topography such as a shape of road, or a local information such as a school-zone as described below), an absolute velocity of the object a relative velocity of the object with respect to the vehicle, or a shift vale of the vehicle with respect to the traffic lane, increases an accuracy of the relative position, relative velocity and direction of each of the objects with sensor fusion, and forms a relative position map and relative velocity directional vectors of the vehicle and the objects (the other vehicle, pedestrian and obstacle) to be transmitted to the safety keeping area extension calculator 106 through the inputting device 111. FIG. 2 shows an example map of the map and the relative velocity directional vectors. In the map of FIG. 2, a zero point 202 is a front end of the vehicle 1, y coordinate 203 is along a traveling direction of the vehicle 1, and x coordinate 204 is perpendicular to the traveling direction. The other vehicles 205 and 206 and the pedestrian 207 is indicated in accordance with the position ands and relative velocities thereof detected by the radar or camera and improved in accuracy by the sensor fusion. The relative velocities with respect to the vehicle 1 and their directional vectors 208, 209 and 210 are indicated on the other vehicles 205 and 206 and the pedestrian 207. The traffic lane 211 detected by the camera is indicated. FIG. 2 is imaginarily formed, and actually, a numerical table as shown in FIG. 3 is prepared. FIG. 3 includes a number 301 of the objects (the other vehicle, pedestrian and obstacle), a distance 302 from the traffic lane, a relative position (303, 304) of each of the objects in x and y directions, and relative velocities (305, 306) in the x and y directions.

The vehicle position velocity traveling direction detector 104 is described below. The vehicle position velocity traveling direction detector 104 determines a position of the vehicle in east-longitude, north-latitude, traveling direction, absolute velocity and altitude from GPS (Global Positioning System) of navigation. The direction may be compensated along gyroscope or earth magnetism. The velocity may be measured by a velocity sensor of the vehicle. The position of the vehicle may be compensated along a position correcting signal received from a beacon. The determined position, absolute-velocity and altitude are transmitted to the vehicle ahead road shape detector 105 and the safety keeping area extension calculator 106 through the inputting device 111.

The vehicle position velocity traveling direction detector 104 may provide in addition to the above information, local information such as date, time, school zone, characteristic of city, town or country, weather, dangerous point or area caused by construction or known from experience and so forth. The safety keeping area extension calculator 106 may determine the safety keeping area on the basis of the above information. For example, the safety keeping area is enlarged in response to the information of the school zone.

Incidentally, the information is input through the inputting device 111 from the object recognizing device 103, the vehicle position velocity traveling direction detector 104 and the vehicle ahead road shape detector 105 into the safety keeping area extension calculator 106 in this embodiment, and the inputting device 111 is an interface for receiving the information through LAN or connector in the vehicle from the object recognizing device 103, the vehicle position velocity traveling direction detector 104 and the vehicle ahead road shape detector 105 incorporated in the camera, radar or navigation device. Therefore, when at least one of the object recognizing device 103, the vehicle position velocity traveling direction detector 104 and the vehicle ahead road shape detector 105 is incorporated as another CPU in the vehicle collision avoidance equipment as the embodiment of the invention, the inputting device is a signal transmission line. Alternatively, when functions of those are incorporated as application or driver in the vehicle collision avoidance equipment, the inputting device is an interface software for the application or driver. When the vehicle ahead road shape detector 105 is incorporated in the vehicle collision avoidance equipment, the inputting device 111 is incorporated between the vehicle position velocity traveling direction detector 104 and the vehicle ahead road shape detector 105. Further, the vehicle collision avoidance equipment as the embodiment as well as the inputting device may be incorporated in an engine controller, a following distance controller or a combined controller.

A method for measuring the traveling direction is described below. The traveling direction is measured from a direction indicator or a steering wheel angular sensor. Alternatively, a timing of changing the traffic lane is estimated from a turning position along a traveling course predetermined by the navigation. The traveling course predetermined by the navigation includes the turning position on which the timing of changing the traffic lane is estimated. The changing the traffic lane (the traveling course) means proceeding straight, turning to left, turning to right, moving to left traffic lane or moving to right traffic lane.

The vehicle ahead road shape detector 105 makes reference to a part of the map selected in accordance with the position and traveling direction and altitude of the vehicle obtained by the vehicle position velocity traveling direction detector 104. The map includes information of, for example, the shape of road, usable traffic lane, and a variation in shape of the road along the traveling direction. The information on the map including an image information and information of a traffic lane adjacent to the traveling course are transmitted to the safety keeping area extension calculator 106.

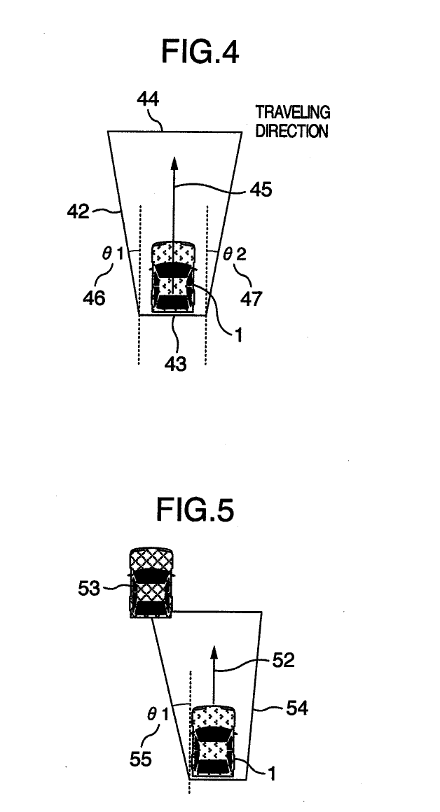

The safety keeping area extension calculator 106 sets the safety keeping area for each of the detected objects (the other vehicle and the pedestrian), and calculates an extension of the safety keeping area. In other words, the imaginary safety keeping area around the vehicle is formed in accordance with relative physical values with respect to the object. An example of the safety keeping area is described with making reference to FIG. 4.

In FIG. 4, the safety keeping area 42 of trapezoid is formed around the vehicle 1. Upper and lower bottoms 43 and 44 are perpendicular to the traveling direction 45 of the vehicle 1. A length of the lower bottom is a width of the vehicle with an opened door so that a margin is formed to prevent the collision against the other vehicle when the door of the vehicle is opened undesirably. The upper bottom is longer than the lower bottom to correspond to a transverse movement of the vehicle in accordance with the change in traveling direction of the vehicle 1 so that the safety keeping area enables the vehicle to be prevented from colliding against the other vehicle. A range of the change in traveling direction is predetermined in accordance with the past actual change in traveling direction by a driver. Alternatively, a coefficient may be predetermined. In such construction, a provability of collision against the other vehicle caused by the change in traveling direction of the vehicle 1 is decreased.

The lower the absolute velocity of the vehicle is, the greater the degree of expanding the safety keeping area toward the other moving body or in a transverse directional component of the predetermined change in traveling direction is.

The safety keeping area may be formed by any closed curve expanding radially from the vehicle 1 other than the trapezoid. A method for determining an angle θ1 (46) of a left side of the safety keeping area 42 and an angle θ2 (47) of a right side of the safety keeping area 42 is described below. In this embodiment, the left and right sides of the safety keeping area are symmetrical to each other with θ1=θ2 so that θ1 is calculated along formula 1 from the lengths of the upper and lower bottoms.

θ1=atn[(length of upper bottom−length of lower bottom)/2×length of safety keeping area] Formula 1

atn: inverse function of function atn to calculate angle

The length of the safety keeping area is described below. The length of the safety keeping area may be calculated from the absolute velocity of the vehicle 1 or the relative velocity between the vehicle and the object. When the length of the safety keeping area is calculated from the relative velocity between the vehicle and the object, the length of the safety keeping area is a length to the collision against the other vehicle with the deceleration of the vehicle 1 and the relative velocity as calculated along formula 2.

Length of safety keeping area=freely running time period×relative velocity+(relative velocity)²×2/maximum deceleration formula 2

A component of the relative velocity in the traveling direction or an absolute value of the relative velocity vector may be used as the relative velocity. When the other vehicle is in front of the vehicle 1 and the length calculated along the formula 2 has negative value, that is, the other vehicle moves away from the vehicle, the safety keeping area is not formed, or alternatively a maximum one of the safety keeping area (rectangular area as parking space) may be formed. The freely running time period in the formula 2 is a predetermined time period from outputting a control signal to bringing the control into effect. The freely running time period may be zero. The maximum deceleration in the formula 2 is a predetermined deceleration of the system, for example, 0.2 G (G: acceleration of gravity).

When the absolute velocity of the vehicle 1 is used to form the safety keeping area, the length of the safety keeping area is calculated with using the absolute velocity of the vehicle 1 as substitute for the relative velocity in the formula 2.

The safety keeping area shown in FIG. 4 is formed for each of the other object (for example, the other vehicle and the pedestrian) around the vehicle 1, or alternatively, the safety keeping area of the vehicle 1 may be formed in accordance with the absolute velocity of the vehicle 1.

In FIG. 5, the extension of the safety keeping area toward the other vehicle is shown. In FIG. 5, the other vehicle 53 exists at a position distant leftward and forward in the traveling direction 52 from the vehicle 1. Under this situation, the safety keeping area 54 of unsymmetrical trapezoid is formed. The extension of left side of the upper bottom may be determined from the relative velocity of the other vehicle in the transverse direction along formula 3.

Extension of left side of upper bottom=freely running time period×relative velocity in transverse direction+(relative velocity in transverse direction)²×2/maximum deceleration formula 3

When the calculated result of the formula 3 has negative value, the extension of left side of upper bottom is made zero or a predetermined value.

Further, the angle θ1 (55) of the left side is calculated along formula 4.

θ1=atn[extended length of left side of upper bottom/length of safety keeping length] formula 4

FIG. 5 shows the extension of left side of upper bottom, and similar extension is determined at right side of the upper bottom when the other vehicle exists at the right side.

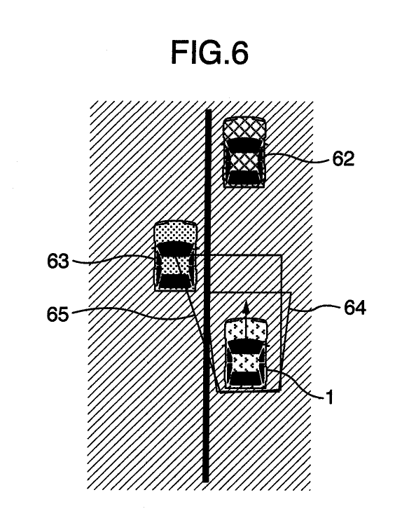

A method for a plurality of the safety keeping areas for a plurality of the other vehicles respectively is described below. In FIG. 6, the other vehicle 62 exists in front of the vehicle 1 along the traveling direction thereof, and the other vehicle 63 exists on a left and forward position with respect to the vehicle 1. When the plurality of the other vehicles exist, the safety keeping areas 64 and 65 for the respective other vehicles are formed around the vehicle 1. The safety keeping area 64 is for the other vehicle 62 existing in front of the vehicle 1 along the traveling direction of the vehicle 1 without a transverse displacement so that the safety keeping area 64 is of symmetrical trapezoid. The safety keeping area 65 is for the other vehicle 63 existing on the left and forward position with respect to the vehicle 1 with a leftward transverse displacement with respect to the vehicle 1 so that the safety keeping area 65 has the leftward extension. The length of the safety keeping area is determined in accordance with the above described relative velocity so that the safety keeping area for the other vehicle moving away from the vehicle 1 is made small to prevent a braking. The safety keeping area for the other vehicle moving toward the vehicle 1 is made great to increase a provability of the braking.

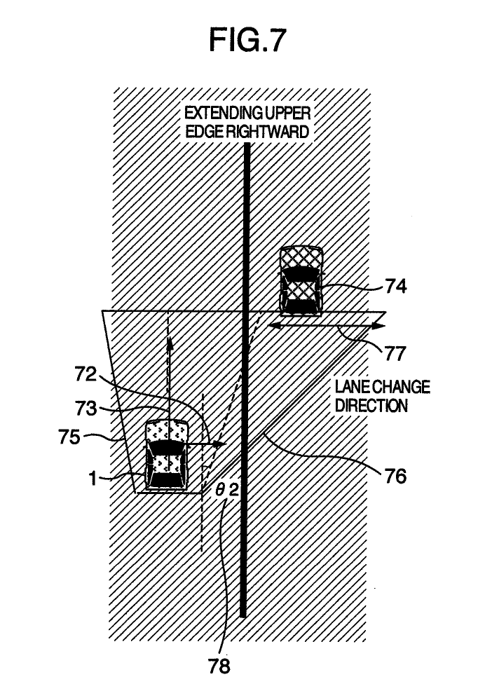

A method for determining the extension of the safety keeping area toward the adjacent traffic lane in accordance with the predetermined change in traveling direction of the vehicle 1 is described with making reference to FIG. 7. In FIG. 7, the vehicle 1 moves toward a right traffic lane 72. The vehicle 1 has the traveling course 73 on the left traffic lane and the other vehicle 74 exists at the right and forward position with respect to the vehicle 1 so that the safety keeping area 75 for the other vehicle is extended rightward as described above. On the other hand, since the vehicle 1 will move rightward, the safety keeping area is extended further rightward to form the safety keeping area 76. An extended length of the upper bottom of the safety keeping area 77 is made equal to a width of the right traffic lane or a constant value. A right angle θ2 (78) is calculated along formula 5.

02=atn[extended length of right side of upper bottom/length of safety keeping area] formula 5

When the vehicle will move toward the adjacent traffic lane, the safety keeping area of the vehicle 1 is extended to the adjacent traffic lane so that the vehicle is capable of escaping from the collision against the other vehicle on the adjacent traffic lane while prevented from being decelerated with respect to the other vehicle.

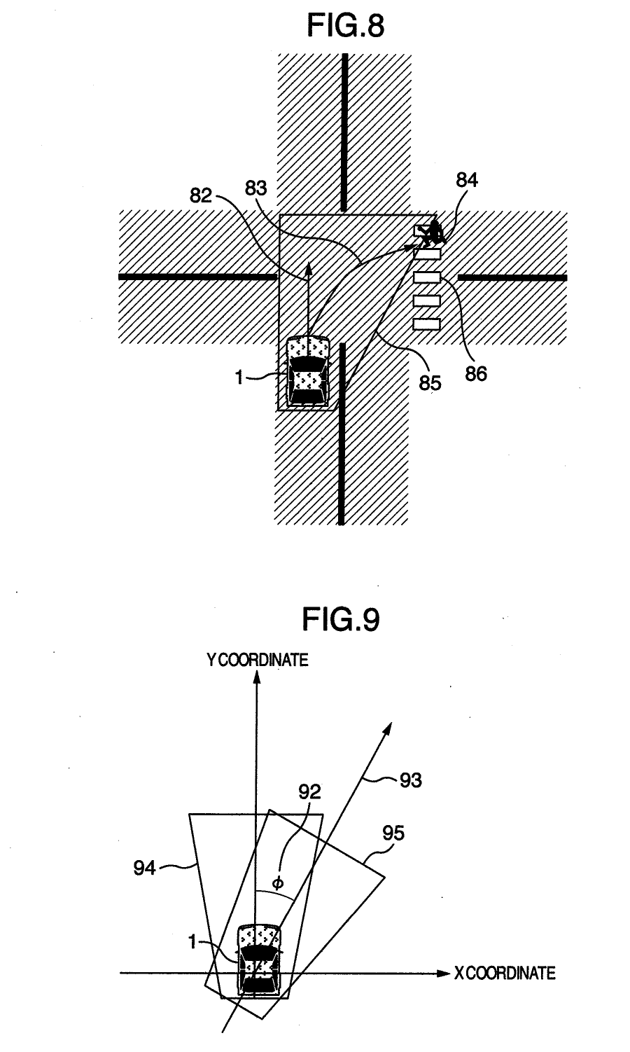

A method for extending the safety keeping area when turning to the right at a traffic intersection is described with making reference to FIG. 8. In FIG. 8, the vehicle 1 keeps its traveling direction 82 straight before turning to the right, and it is intended on the basis of the direction indicator, the information of the navigation system along the predetermined traveling course or the angle of the steering wheel that the vehicle 1 moves along a rightward turning course 83. Under such situation, the safety keeping area 85 for the pedestrian 84 is extended to a pedestrian crossing 86. The extension of right side of the safety keeping area includes the pedestrian and a width of the traffic lane through which the vehicle turns to the right. The safety keeping area may be unconditionally extended to the pedestrian crossing. When turning to the left, the safety keeping area is extended similarly.

When moving along a left-hand or right-hand curve, the safety keeping area may be modified in accordance with a front road shape of the vehicle, that is, the shape of the curve.

A method for determining the safety keeping area when the steering wheel of the vehicle is rotated to turn is described with making reference to FIG. 9. In FIG. 9, the steering wheel is rotated but the traveling direction of the vehicle 1 does not change yet. The traveling direction will change to be directed to a direction 93 of angle φ (92) in accordance with the rotation of the steering wheel. Under such situation, the safety keeping area 94 is rotated by the angle φ to the safety keeping area 95.

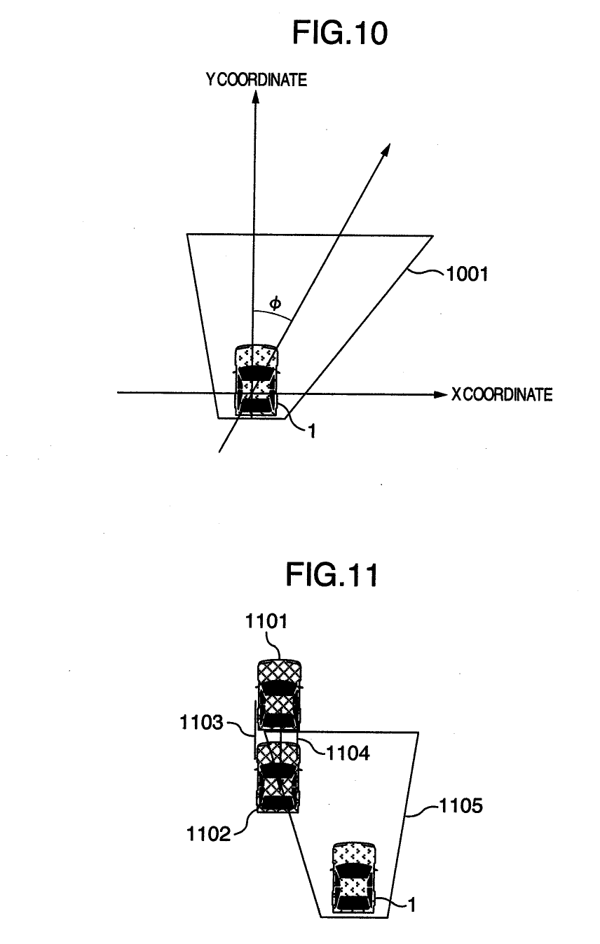

Alternatively, when the steering wheel is rotated, as shown in FIG. 10, the safety keeping area may be extended in accordance with a rotating direction of the steering wheel to form the safety keeping area 1001 without being rotated. A length of the extension of right side of the upper bottom may be calculated along formula 6.

Length of extension of right side of upper bottom=sin φ×length of safety keeping area formula 6

The other vehicle safety keeping area intrusion detector 107 is described below. The other vehicle safety keeping area intrusion detector decides as to whether the object exists or will exist in the safety keeping area determined for each of the objects and calculated by the safety keeping area extension calculator 106. That is, the other vehicle safety keeping area intrusion detector decides whether or not the object exists or will exist in the safety keeping area. When the object exists or will exist in the safety keeping area, the deceleration or the angular velocity of the steering wheel is set by the vehicle deceleration velocity steering-wheel setting device 108.

A method for forecasting a proceeding of the other vehicle into the safety keeping area of the vehicle is described with making reference to FIG. 11. As shown in FIG. 11, a position 1102 of the other vehicle after T seconds is calculated by a product of the relative velocity vector of the other vehicle 1101 and the T seconds. Each of imaginary envelopes 1103 and 1104 connects a current position of the other vehicle and the position of the other vehicle after the T seconds to each other. If the safety keeping area 1105 covers at least partially the current position of the other vehicle, the position of the other vehicle after the T seconds or the envelopes, it is decided that the other vehicle will proceed into the safety keeping area of the vehicle. Such decision may be carried out when a future trajectory of the other vehicle covers at least partially the safety keeping area 1105. It is decided when the situation of FIG. 11 occurs that the other vehicle will proceed into the safety keeping area of the vehicle. The number T of seconds may be a time period for making the vehicle stop with a radical deceleration as calculated along formula 7.

T=(absolute velocity of vehicle)²/(2×maximum value of radical deceleration) formula 7

For example, the maximum value of radical deceleration may be 0.2 G (G: acceleration of gravity) to calculate the T.

The above described decisions are carried out for each of the objects.

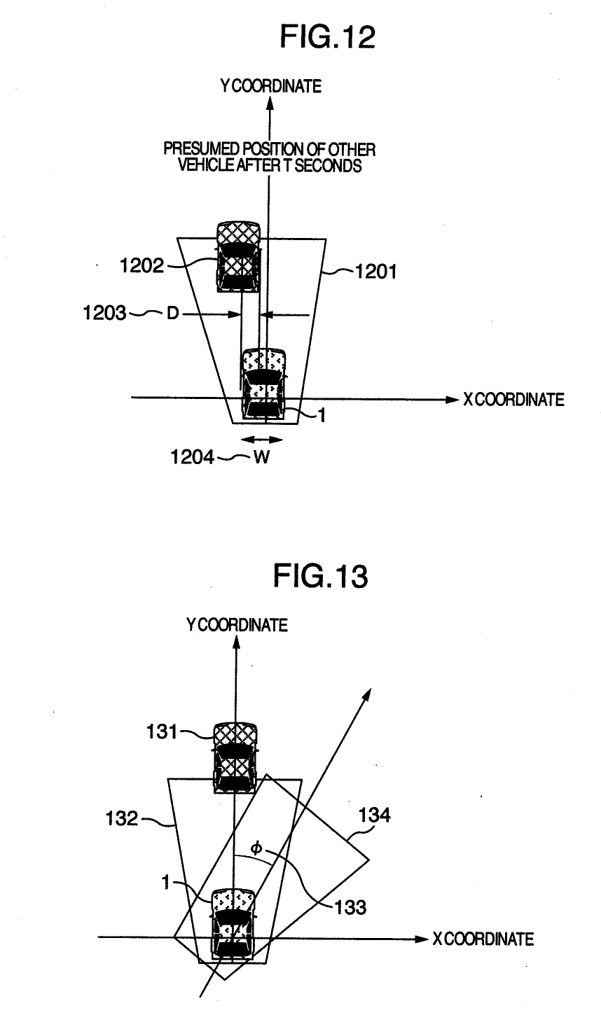

The vehicle deceleration velocity steering-wheel setting device 108 is described below. A method for determining the deceleration and the rotating angle of the steering wheel when each of the objects proceeds into the safety keeping area, is described with making reference to FIG. 12. When it is decided that the other vehicle proceeds into the safety keeping area 1201 after the T seconds, a desired deceleration may be calculated along formula 8 from a distance in y direction between the other vehicle 1202 and the vehicle after the T seconds, a relative velocity in the y direction (traveling direction of the vehicle) between the other vehicle 1202 and the vehicle, and an offset rate as a rate of overlap between the other vehicle and the vehicle to be compensated.

Deceleration=(relative velocity in y direction)²/(2×distance in y direction)×offset rate formula 8

The offset rate may be calculated as a rate between an overlap length D1203 between the vehicle 1 and the other vehicle and a width W1204 of the vehicle, that is, D/W, as (D+δ)/W (δ: door width of the vehicle and door width of the other vehicle), or as a length of a part of the other vehicle in the safety keeping area and a length of the safety keeping area in the transverse direction. D may have negative value. When the offset rate is (D+δ)/W, there is an effect of that the door of the vehicle is prevented from colliding against the other vehicle even when the door is opened suddenly. Each of the deceleration and the offset rate may be calculated from the current position of the object other than the position of the object after the T seconds. When the calculated offset rate is not more than zero, the offset may be zero for further calculation.

The collision may be prevented by an operation of the steering wheel. A method thereof is described below. For preventing the safety keeping area from overlapping the other vehicle after the T seconds, the safety keeping area is rotated as shown in FIG. 13. In FIG. 13, the other vehicle 131 will proceed into the safety keeping area after the T seconds. A rotating angle φ 133 is determined to rotate the safety keeping area so that the other vehicle is prevented from proceeding into the safety keeping area. The rotated safety keeping area is denoted by 134. An angular velocity of the rotated steering wheel is φ/T.

These operation are carried out for each of the detected objects, and the highest one of the calculated deceleration is selected. For preventing the steering wheel from being rotated rapidly so that the vehicle is prevented from becoming unstable, relatively lower one of the calculated angular velocities of the rotated steering wheel is selected.

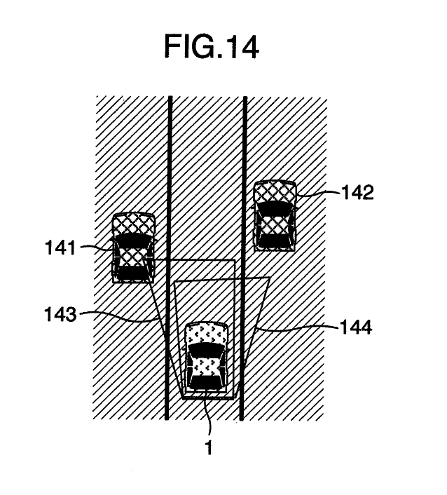

A case where the vehicle passes between the other vehicles is described with making reference to FIG. 14. Under such case, the other vehicles 141 and 142 proceed in the same direction. The other vehicle 141 has the safety keeping area 143 and the other vehicle 142 has the safety keeping area 144. As a result of calculating the offset rate and the deceleration as described above, when the deceleration of the other vehicle 141 is 0.1 G (G: acceleration of gravity) and the deceleration of the other vehicle 142 is 0.2 G, the greater one of the calculated decelerations is selected to determine the deceleration of the vehicle as 0.2 G.

Finally, the velocity steering-wheel controller 109 is described. The velocity steering-wheel controller outputs to the steering wheel and the brake controller ECU (Electric Control Unit) the deceleration calculated by the vehicle deceleration velocity steering-wheel setting device 108 or a change of velocity along time proceeding calculated from the deceleration, and the angular velocity of the steering wheel or a change in angle of the steering wheel calculated from the angular velocity so that the vehicle is controlled on the basis of such information.

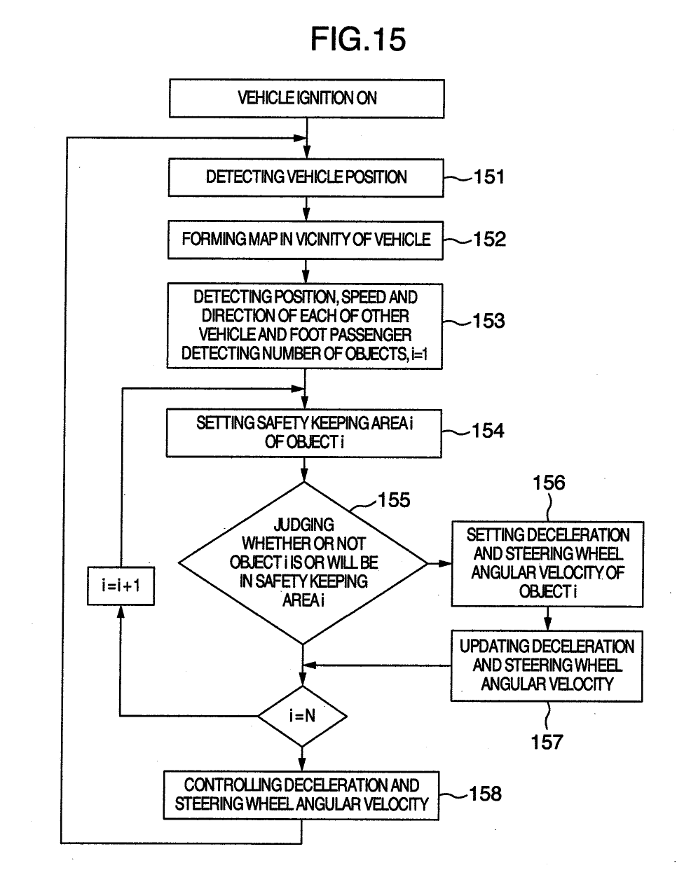

A control flow of the system is described below with making reference to a sequence diagram of FIG. 15. The system is active from turning on an ignition of the vehicle to turning off the ignition. After the ignition is turned on to activate the system, a position of the vehicle is measured continuously at step 151, a map of the vicinity of the vehicle is formed at step 152, and the other object (the other vehicle or pedestrian) is detected at step 153. The step 151 corresponds to the vehicle position velocity traveling direction detector 104 in FIG. 1, the step 152 corresponds to the vehicle ahead road shape detector 105 in FIG. 1, and the step 153 corresponds to the object recognizing device 103.

Original values of the angular velocity of the steering wheel and the deceleration are set at zero. For each of the detected other objects whose total number is N, the safety keeping area is set at step 154, it is decided at step 155 as to whether or not the object is or will be in the safety keeping area, and the deceleration or the angular velocity of the steering wheel is determined at step 156 if the object is or will be in the safety keeping area. If the determined deceleration or angular velocity of the steering wheel is maximum in comparison with the previously determined deceleration or angular velocity of the steering wheel, the previously determined deceleration or angular velocity of the steering wheel as a desirable value for preventing the collision is replaced at step 157 by the newly determined deceleration or angular velocity of the steering wheel. The step 154 corresponds to the safety keeping area extension calculator 106 in FIG. 1, the step 155 corresponds to the other vehicle safety keeping area intrusion detector 107 in FIG. 1, and the steps 156 and 157 corresponds to the vehicle deceleration velocity steering-wheel setting device 108 in FIG. 1.

After the steps 154-158 are carried out for each of the objects, the deceleration and the angular velocity of the steering wheel are transmitted to the vehicle controller to control the vehicle at step 159. The step 159 corresponds to the velocity steering-wheel controller 109 in FIG. 1.

A method for indicating the information for the vehicle driver in the system is described. For indicating the information for the vehicle driver, a display and the system output an alarm before performing the collision avoidance operation. The display as a head-up display or a navigator display shows the map of FIG. 2 and the movable body moving toward the safety keeping area with accentuating the movable body. The safety keeping area of each of the movable bodies may be shown. As the alarm, the display may generate flush or beep.

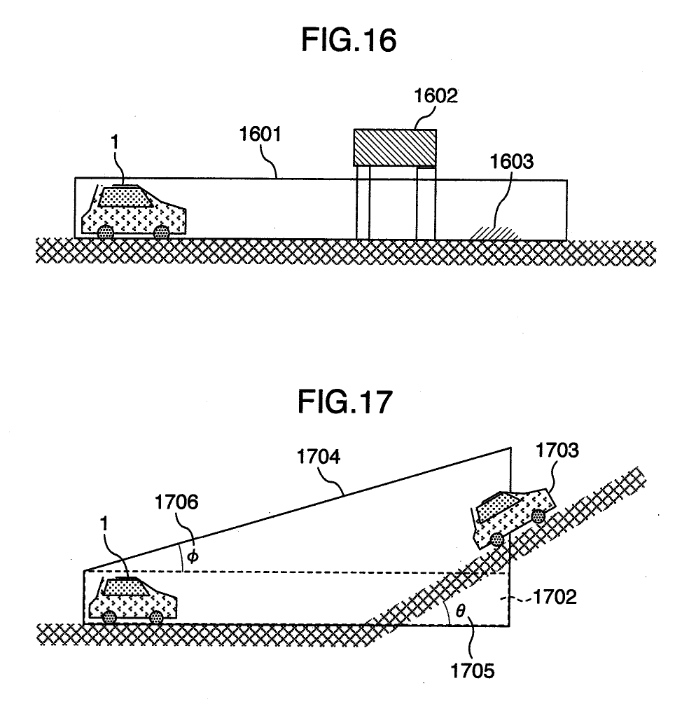

The vertical extension of the safety keeping area in the embodiment is described with making reference to FIG. 16. The safety keeping area as shown in FIG. 4 is extended vertically by a height of the vehicle and a margin thereof. The vehicle ahead road shape detector 105 in FIG. 1 calculates a height of an overbridge 1602 over a road in front of the vehicle. A vertical offset rate between the height of the overbridge 1602 and a height of the safety keeping area 1601 of the vehicle 1 is calculated to control in accordance with a product of the vertical offset rate and the deceleration calculated along the formula 8. The vertical offset rate may be calculated along [height of the overbridge−(height of the vehicle+δ)]/height of the vehicle. The value δ is a predetermined degree of vertical movement of the vehicle. The offset rate for a bump 1603 under the vehicle 1 is calculated similarly. The other vehicle safety keeping area intrusion detector 107 determines the deceleration of the vehicle 1 in accordance with the offset rate. When the offset rate has positive value to indicate that the vehicle cannot pass under the overbridge, the deceleration is determined to make the vehicle stop before reaching the overbridge. When the offset rate has negative value to indicate that the vehicle can pass under the overbridge but has a small margin to indicate that a road condition causes a provability of the vehicle 1 contacts the overbridge 1602, the deceleration is determined to decrease the velocity of the vehicle 1 to a slow velocity before reaching the overbridge. When the offset rate has negative value and a sufficient margin, the deceleration is not performed. In a case for the bump, the similar operation may be carried out, but the deceleration may be determined in response to the bump irrespective of the offset rate to decrease the velocity of the vehicle to the small velocity (or a velocity for preventing the bump from contacting a lower part of the vehicle when the vehicle bounds) before reaching the overbridge.

The vertical extension of the safety keeping area in the embodiment for a slope is described below with making reference to FIG. 17. The safety keeping area vertically extending has preferably a rectangular shape for a level road, but there is a provability of that the other vehicle proceeding on an upward slope in front of the vehicle is prevented from being covered by the safety keeping area of the rectangular shape. Therefore, in such case, the safety keeping area has preferably a trapezoidal shape modified from the rectangular shape in accordance with an inclination of the upward slope in front of the vehicle. As shown in FIG. 17, if the vehicle proceeds on the level road and has the safety keeping area 1702 extending vertically to have the rectangular shape (denoted by dot line), the deceleration is not generated for the other vehicle 1703 which is sufficiently close to generate the deceleration but is not covered by the safety keeping area 1702. Therefore, the safety keeping area 1702 is converted to the safety keeping area 1704 of trapezoid in accordance with a difference between the inclination of the road under the vehicle 1 and the inclination of the road in front of the vehicle 1. The conversion of the safety keeping area is adjusted in accordance with value and sign of an inclination difference θ 1705, and the safety keeping area is expanded upward to have an angle 1706 when the sign is positive (the road in front of the vehicle is the upward slope. When the sign is negative (the road in front of the vehicle is a downward slope), the safety keeping area is expanded downward. The value of θ may be equal to φ. The inclination of the road in front of the vehicle and the inclination of the road under the vehicle may be obtained from information of the map in the navigation system.

How the embodiment is applicable to a provability of that the other vehicle behind the vehicle 1 collides with the vehicle is described below. When the other vehicle behind the vehicle 1 has the relative velocity of positive value, the safety keeping area is formed to cover a back side of the vehicle 1 so that a provability of collision of the other vehicle with the vehicle is decided from whether or not the other vehicle behind the vehicle is or will be in the safety keeping area. When there is the provability of collision of the other vehicle with the vehicle, the deceleration obtained along the formula 8 is made negative, that is, the vehicle is accelerated.

A method for decreasing an influence of the inclination by measuring the inclination under the vehicle to expand forward in the traveling direction the safety keeping area when the inclination is negative, that is, the vehicle proceeds on the downward slope and to shorten backward the safety keeping area when the vehicle proceeds on the upward slope, is described below. For example, the length of the safety keeping area of the vehicle may be calculated along the formula 2 from a total amount of the maximum deceleration of the vehicle and the acceleration of gravity by the inclination. The inclination of the road under the vehicle may be obtained from an acceleration sensor or information of the inclination recorded on the map and read out in accordance with the position of the vehicle measured by GPS (Global Positioning System).

A method for decreasing a difference between the automatic collision avoiding operation and a collision avoiding operation by the driver by expanding the safety keeping area in accordance with an increase of the deceleration ordered by the driver, an increase of reaction delay of the driver or an increase of fatigue degree of the driver, is described below. When the driver shows the increase of the ordered deceleration, the increase of reaction delay or the increase of fatigue degree, a margin is added to the safety keeping area obtained along the formula 2. The margin is determined from a table including a relation ship between the margin and each of the ordered deceleration, the reaction delay or the fatigue degree. A degree of change in the ordered deceleration is calculated from a standard deviation of the deceleration and a degree of distortion thereof obtained from the vehicle as disclosed by “Sharyou-jouhou wo katsuyousita telematique anzen-unten-shien eno torikumi” by Tanikoshi et al. in Hitachi-hyouron Vol 88, No. 08, pp-22-25, published on August 2005. The reaction delay may be obtained statistically from the recorded information of the vehicle such as a time period from releasing an accelerator pedal to pressing a brake pedal. The fatigue degree may be obtained from a measured inconscient swing of the steering wheel or a biological information obtained from saliva.

A method for determining the deceleration in accordance with a degree of urgency as a distance between the other object and the vehicle is described below. In this method, a plurality of the safety keeping areas analogous to each other are formed, and the degree of urgency is determined in accordance with which is the closest one of the safety keeping areas penetrated by the other object so that the deceleration is determined as a product of the deceleration calculated along the formula 8 and a coefficient corresponding to the degree of urgency. A relationship between the coefficient and the degree of urgency is predetermined.

The other movable body which is not detected from the movable body can be detected by an infra-communication or a communication between the movable bodies, or the safety keeping area may be formed in a blind region of the movable body.

The embodiments are described above, but in the prior art, for example, in a case where single safety area is formed around the movable body, when the other movable body moving away from the movable body in the transverse direction is in the safety keeping area, the movable body is decelerated.

In a case where the other movable body have the safety keeping areas respectively, the deceleration of the movable body is not performed for the other movable body moving away from the movable body, but a difficulty of forecasting a future traveling direction of the other movable body causes a difficulty of extending or shortening the safety body in the future traveling direction of the other movable body.

Further, since it is difficult for the safety keeping area of the other movable body to be modified in accordance with a future change in traveling direction of the movable body, a logical decision for modifying the safety keeping area of the other movable body in accordance with the future change in traveling direction of the movable body is necessary after forming the safety keeping area of the other movable body, to cause an undesirable calculation amount.

In a method for modifying the safety keeping area along the road shape on the future traveling coarse of the movable body, since the future change in traveling coarse of the movable body is not taken into consideration, it is difficult for the collision avoidance operation is performed when the traveling coarse of the movable body is changed.

Each of the above embodiments solve solves at least one of these problems, and includes means for detecting the other movable bodies with camera or radar, means for determining a safety keeping area for each of the detected other movable bodies and expanding the safety keeping area in a traveling direction of the movable body in accordance with a relative velocity while expanding the safety keeping area toward the other movable body, means for determining a future change in traveling direction of the movable body, means for expanding the safety keeping area in a future traveling direction of the movable body, means for deciding as to whether or not one of the other movable bodies proceeds into corresponding one of the safety keeping areas, means for determining an operation degree for avoiding the collision when it is decided that the one of the other movable bodies proceeds into the corresponding one of the safety keeping areas, and means for at least one of controlling the movable body in accordance with the operation degree and outputting an alarm.

According to this, the safety keeping area for each of the other movable bodies is formed around the movable body, and the collision avoiding operation is prevented from being performed for the other movable body moving away from the movable body. Further, the safety keeping area is modified in accordance with the future change in traveling coarse of the movable body.

In these embodiments, the safety keeping area is expanded in a future traveling direction of the movable body on the basis of the future change in traveling coarse of the movable body, so that for example, a vehicle is prevented from colliding with the other vehicle on a traffic lane adjacent to a traffic lane under the vehicle to be applicable to a shift between the traffic lanes. Further, the safety keeping area is modified in accordance with the future change in traveling coarse of the movable body to make another logical treatment according to the driver's intention unnecessary so that a calculation amount is decreased.

Further, since the safety keeping area is expanded toward the detected movable body, the collision avoiding operation can be performed when the movable body passes between the other movable bodies adjacent to the movable body.

It should be further understood by those skilled in the art that although the foregoing description has been made on embodiments of the invention, the invention is not limited thereto and various changes and modifications may be made without departing from the spirit of the invention and the scope of the appended claims.

1. A collision avoidance apparatus comprising,
an input device for receiving a relative physical value between a movable body and an object such as at least one of the other movable body, an object on the ground, a position on the ground, a topographical feature and a regional information around the movable body,
a safety keeping area determining device for determining an imaginary safety keeping area around the movable body in accordance with the relative physical value,
an object intrusion judging device for deciding as to at least one of whether or not the object is within the safety keeping area and whether or not the object will be within the safety keeping area, and
an output device for performing at least one of controlling for preventing a collision between the movable body and the object and outputting an alarm, when the at least one of that the object is within the safety keeping area and that the object will be within the safety keeping area is decided by the object intrusion judging device.

2. The collision avoidance apparatus according to claim 1, further comprising a relative physical value calculating device for calculating the relative physical value, wherein the input device receives the relative physical value calculated by the relative physical value calculating device.

3. The collision avoidance apparatus according to claim 2, wherein the relative physical value calculating device calculates the relative physical value from a signal generated by an object recognizing device including at least one of a radar and a camera.

4. The collision avoidance apparatus according to claim 2, wherein the relative physical value calculating device calculates from a signal generated by a navigation device a position, velocity and a traveling direction of the movable body as the relative physical value.

5. The collision avoidance apparatus according to claim 2, wherein the relative physical value calculating device calculates from a signal generated by at least one of a direction indicator, a steering angle sensor and a navigation device indicating a predetermined traveling coarse a traveling direction of the movable body as the relative physical value.

6. The collision avoidance apparatus according to claim 1, wherein the safety keeping area determining device changes a size of the safety keeping area in accordance with the relative physical value.

7. The collision avoidance apparatus according to claim 1, wherein the input device receives the relative physical value between the movable body and each of a plurality of the objects, and the safety keeping area determining device determines the imaginary safety keeping area for each of the objects.

8. The collision avoidance apparatus according to claim 1, wherein the safety keeping area determining device expands the safety keeping area to increase a width of the safety keeping area in a radially outward direction from the movable body.

9. The collision avoidance apparatus according to claim 8, wherein the movable body has a door at its side, and the safety keeping area determining device determines a minimum width of the safety keeping area to be equal to a transverse width of the movable body obtained when the door is opened.

10. The collision avoidance apparatus according to claim 8, wherein the safety keeping area determining device determines a width of the safety keeping area in accordance with an operating tendency for steering wheel by a driver of the movable body.

11. The collision avoidance apparatus according to claim 1, wherein the safety keeping area determining device increases a width of the safety keeping area and changes a ratio of the width of the safety keeping area/an absolute value of a velocity of the movable body so that the greater the absolute value of the velocity of the movable body is, the smaller the ratio is.

12. The collision avoidance apparatus according to claim 1, wherein the safety keeping area determining device determines a length of the safety keeping area in a traveling direction of the movable body in accordance with at least one of a velocity of the movable body with respect to the ground and a relative velocity between the movable body and the object.

13. The collision avoidance apparatus according to claim 12, wherein the safety keeping area determining device determines the length of the safety keeping area in accordance with a time period of free-running of the movable body and a maximum deceleration of the movable body.

14. The collision avoidance apparatus according to claim 13, wherein the maximum deceleration is 0.2 G.

15. The collision avoidance apparatus according to claim 1, wherein the safety keeping area determining device is prevented from determining the safety keeping area for the object moving away from the movable body.

16. The collision avoidance apparatus according to claim 1, wherein the safety keeping area determining device determines for the object moving away from the movable body the safety keeping area to have a minimum value.

17. The collision avoidance apparatus according to claim 1, wherein the output device is prevented from performing for the object moving away from the movable body the at least one of controlling for preventing the collision between the movable body and the object and outputting the alarm.

18. The collision avoidance apparatus according to claim 1, wherein the safety keeping area determining device determines a width of the safety keeping area at a side thereof facing to the object in accordance with a relative velocity in transverse direction between the movable body and the object.

19. The collision avoidance apparatus according to claim 1, wherein when the movable body moves from a traffic lane to another traffic lane, the safety keeping area determining device increases a width of the safety keeping area at a side thereof facing to the another traffic lane.

20. The collision avoidance apparatus according to claim 1, wherein the safety keeping area determining device determines a traveling direction of the movable body from a signal generated by at least one of a direction indicator, a steering angle sensor and a navigation device indicating a predetermined traveling coarse, and expands the safety keeping area in the traveling direction.

21. The collision avoidance apparatus according to claim 20, wherein when the movable body turns at a traffic intersection to pass a pedestrian crossing, the safety keeping area determining device expands the safety keeping area to cover the pedestrian crossing.

22. The collision avoidance apparatus according to claim 1, wherein when the movable body proceeds along a curved coarse, the safety keeping area determining device deforms the safety keeping area to be curved.

23. The collision avoidance apparatus according to claim 1, wherein the safety keeping area determining device rotates the safety keeping area in accordance with a steering angle to follow a change in orientation of the movable body ordered by the steering angle.

24. The collision avoidance apparatus according to claim 1, wherein the safety keeping area determining device modifies the safety keeping area in accordance with a steering angle to be expanded in a traveling direction of the movable body ordered by the steering angle.

25. The collision avoidance apparatus according to claim 1, wherein the object intrusion judging device forecasts a future traveling coarse of the other object, and when the future traveling coarse of the other object is at least partially covered by the safety keeping area, the object intrusion judging device decides that the object will be within the safety keeping area.

26. The collision avoidance apparatus according to claim 1, wherein when the object intrusion judging device decides that the object will be within the safety keeping area, the output device calculates a deceleration of the movable body from a combination of an offset rate and a relative velocity and distance between the movable body and the object which combination is obtained when the object reaches the safety keeping area, and outputs the deceleration to the movable body to prevent the collision between the movable body and the object.

27. The collision avoidance apparatus according to claim 26, wherein when the object intrusion judging device decides that each of a plurality of the objects will be within the safety keeping area, the output device calculates a deceleration of the movable body from a combination of an offset rate and a relative velocity and distance between the movable body and each of the objects which combination is obtained when each of the objects reaches the safety keeping area, and the output device outputs the greatest one in absolute value of the decelerations to the movable body.

28. The collision avoidance apparatus according to claim 1, wherein when the object intrusion judging device decides that the object will be within the safety keeping area, the output device outputs a signal for ordering a steering angle to rotate the safety keeping area in accordance with the steering angle so that the object is prevented from proceeding into the safety keeping area.

29. The collision avoidance apparatus according to claim 28, wherein when the object intrusion judging device decides that each of a plurality of the objects will be within the safety keeping area, the output device calculates the signal for ordering the steering angle to rotate the safety keeping area in accordance with the steering angle so that each of the objects is prevented from proceeding into the safety keeping area, and the output device outputs the greatest one of the steering angles

30. The collision avoidance apparatus according to claim 1, wherein the output device outputs a signal for showing on a display at least one of the safety keeping area, the object which is within the safety keeping area, the object which will be within the safety keeping area.

31. The collision avoidance apparatus according to claim 1, wherein the safety keeping area extends vertically.

32. The collision avoidance apparatus according to claim 1, wherein the safety keeping area determining device expands the safety keeping area in a direction opposite to a traveling direction of the movable body when the object exists behind the movable body and moves toward the movable body, and when the object intrusion judging device decides the at least one of that the object is within the safety keeping area and that the object will be within the safety keeping area, the output device outputs a signal for accelerating the movable body.

33. The collision avoidance apparatus according to claim 1, wherein the safety keeping area determining device expands the safety keeping area in a traveling direction of the movable body when the movable body moves on a downward slope, and shortens the safety keeping area along the traveling direction of the movable body when the movable body moves on an upward slope.

34. The collision avoidance apparatus according to claim 1, wherein the safety keeping area determining device expands the safety keeping area when at least one of an increase in absolute value of deceleration ordered by a driver for the movable body, an increase in time period for a response by the driver, and an increase in fatigue of the driver.

35. The collision avoidance apparatus according to claim 1, wherein the safety keeping area determining device determines the safety keeping area on the basis of information of the object received from at least one of an infra-communication and a communication between the movable object and the other movable object.

36. A method for avoiding a collision, comprising the steps of:
receiving a relative physical value between a movable body and an object such as at least one of the other movable body, an object on the ground, a position on the ground, a topographical feature and a regional information around the movable body,
determining an imaginary safety keeping area around the movable body in accordance with the relative physical value,
performing at least one of controlling for preventing the collision between the movable body and the object and outputting an alarm, when deciding the at least one of that the object is within the safety keeping area and that the object will be within the safety keeping area.
